(19) United States
(12) Patent Application Publication
(10) Pub. No.: US 2016/0114852 A1
(43) Pub. Date: Apr. 28, 2016

(54) FOLDING BICYCLE

(71) Applicant: Sang-Ki BAEK, Yongin-si (KR)

(72) Inventor: Sang-Ki BAEK, Yongin-si (KR)

(21) Appl. No.: 14/892,370

(22) PCT Filed: Dec. 4, 2014
(86) PCT No.: PCT/KR2014/011822

§ 371 Date: Nov. 19, 2015

(30) Foreign Application Priority Data
Dec. 5, 2013 (KR) 10-2013-0150304
Dec. 27, 2013 (KR) 10-2013-0164707

(51) Int. Cl. B62K 15/00; B62K 3/00

(52) U.S. Cl. CPC B62K 15/008; B62K 3/00

(57) ABSTRACT

An embodiment of the present invention may provide a folding bicycle comprising: a front frame connected to a front wheel; a rear frame connected to a rear wheel; an upper frame connected to a first end of the rear frame and formed to be foldable; a pedal frame connected to a second end of the rear frame; and a first hinge unit interposed between the first and of the rea frame and the upper frame and hinge-connected to the first end of the rear frame, wherein, when the bicycle is folded, the rear frame rotates towards the front frame with regard to the first hinge unit.

### TECHNICAL FIELD

Embodiments of the present invention relate to a folding bicycle.

### BACKGROUND ART

In general, a bicycle may be classified into a fixing bicycle and a folding bicycle. Differently from the fixing bicycle, the folding bicycle may be folded to be small when the bicycle is not used, and thus is convenient in terms of keeping and carrying.

An example of the folding bicycle is illustrated in FIGS. 1A and 1B. FIG. 1A is a schematic side view of a folding bicycle. FIG. 1B is a schematic side view of a folded state of the folding bicycle.

Referring to FIGS. 1A and 1B, the folding bicycle may support a load thereof through a frame structure including a rear frame 10 positioned on sides of a saddle 33 and a rear wheel 11, a front frame 20 positioned on a side of a handle 24, an upper frame 30, and a pedal unit 40 at which a pedal 45 is installed. If the bicycle is not used, the upper frame 30 may be folded to keep the bicycle.

However, the folding bicycle as shown in FIGS. 1A and 1B has a structure, in which the upper frame 30 is folded, and thus occupies a constant volume and has a limitation of being small.

### DETAILED DESCRIPTION OF THE INVENTION

### Technical Problem

Embodiments of the present invention provide a folding bicycle that becomes smaller when being folded to be easily kept, transported, and carried.

### Technical Solution

According to an aspect of the present invention, there is provided a folding bicycle including: a front frame connected to a front wheel; a rear frame connected to a rear wheel; an upper frame connected to a first end of the rear frame and which is foldable; a pedal frame connected to a second end of the rear frame; a first hinge unit interposed between the first end of the rear frame and the upper frame and hinge-connectable to the first end of the rear frame; a first connection guide configured to be positioned on a side of the upper frame; and a second connection guide configured to be positioned on a side of the pedal frame opposite to the first connection guide.

The second connection guide may be coupled with the first connection guide so as to be separated from the first connection guide. When the second connection guide is separated from the first connection guide, the rear frame may rotate with respect to the first hinge unit toward the front frame.

The first connection guide and the second connection guide may be connected to each other by a hinge axis to form a pedal frame hinge unit. When the pedal frame rotates on the hinge axis, the first end of the rear frame may rotate with regard to the first hinge unit toward the front frame.

The rear frame may include: a first sub-rear frame, wherein an end of the first sub-rear frame is hinge-connected to the first hinge unit; and a second sub-rear frame, wherein an end of the second sub-rear frame coupled with another end of the first sub-rear frame, and another end of the second sub-rear frame connected to the pedal frame. A rotation axis of the rear wheel may be formed in at least one selected from the first and second sub-rear frames.

The second sub-rear frame may be hinge-connected to the another end of the first sub-rear frame. A hinge axis, which is formed by a hinge-connection between the first sub-rear frame and the second sub-rear frame, may be located in a position different from a position of a rotation axis of the rear wheel.

The pedal frame may be hinge-connected to the second end of the rear frame. A hinge axis, which is formed by a hinge-connection between the pedal frame and the second end of the rear frame, may be located in a position different from a position of a pedal axis.

The folding bicycle may further include: a first fixing unit formed at the upper frame; and a second fixing unit formed at the rear frame or the pedal frame, and coupled with the first fixing unit when the rear frame rotates.

The folding bicycle may further include a shock absorber including an end connected to the first hinge unit and another end connected to the upper frame.

The pedal frame may further include a pedal assistant frame, wherein an end of pedal assistant frame is hinge-connected to the pedal frame and configured to extend in one direction, and the upper frame further may include an upper assistant frame configured to extend toward the pedal assistant frame. An assistant fixing key may be further included to couple or separate the pedal assistant frame and the upper assistant frame.

The folding bicycle may further include a fixing key configured to control coupling or separating the first connection guide and the second connection guide.

Aspects, characteristics, and merits except the above descriptions will be apparent from claims and detailed description of the invention.

### Advantageous Effects of the Invention

A folding bicycle according to embodiments of the present invention may become smaller when being folded to be easily kept, transported, and carried.

### DESCRIPTION OF THE DRAWINGS

FIG. 1A is a schematic side view of a conventional folding bicycle.

FIG. 1B is a side view of a folded state of the folding bicycle of FIG. 1A.

FIG. 2A is a schematic side view of a folding bicycle according to an embodiment.

FIG. 2B is a detailed side view of IIa of FIG. 2A.

FIG. 3 illustrates a modification of the embodiment of FIG. 2A.

FIGS. 4A through 4D are schematic side views illustrating a process of a folding bicycle according to embodiments.

FIG. 5A is an upper side view of FIG. 4A.

FIG. 5B is an upper side view of FIG. 4D.

FIGS. 6A and 6B are side views of a part of a folding bicycle according to another embodiment.

FIGS. 7A and 7B are schematic rear side views of first and second connection guides according to another embodiment.

FIGS. 8A through 8C are schematic side views of a part of a folding bicycle including the first and second connection guides of FIGS. 7A and 7B, i.e., illustrate a process of folding the bicycle.

FIG. 8D is a schematic rear side view of the first connection guide and a rear wheel of the folding bicycle of FIG. 8C.

FIG. 9 is a detailed side view of a part of a folding bicycle including the first and second connection guides of FIGS. 7A and 7B.

FIG. 10 is a schematic side view of a folding bicycle according to another embodiment.

FIGS. 11A through 11D are schematic side views illustrating a process of folding the folding bicycle of FIG. 10.

FIG. 12 is a detailed side view of a folding bicycle according to an embodiment.

FIG. 13 illustrates a modified embodiment of the folding bicycle of FIG. 12.

FIG. 14A is a side view of a part of an upper frame and a pedal frame of a folding bicycle according to an embodiment.

FIG. 14B is a lower side view of the pedal frame and a pedal assistant frame unit of FIG. 14A.

FIG. 15A is a side view illustrating a rotation of the pedal assistant frame unit of FIG. 14A.

FIG. 15B is a lower side view illustrating a rotation of the pedal assistant frame unit of FIG. 15A.

FIG. 15C is a side view illustrating a rotation of the pedal frame in a state of FIG. 15B.

FIG. 16A is a side view of an upper frame and a pedal frame of a folding bicycle according to another embodiment.

FIG. 16B is a lower side view of the pedal frame and a pedal assistant frame unit of FIG. 16A.

FIG. 16C is a side view illustrating a rotation of the pedal assistant frame unit of FIG. 16A.

FIG. 16D is a lower side view illustrating a rotation of the pedal assistant frame unit of FIG. 16C.

FIG. 16E is a side view of an assistant a fixing key of FIG. 16A.

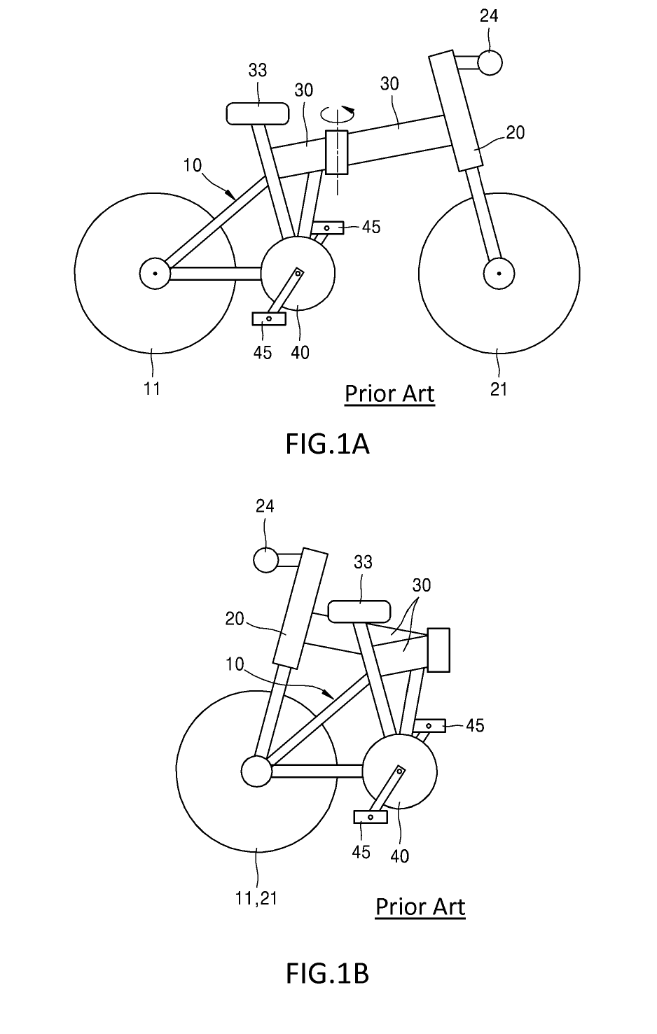

### MODE OF THE INVENTION

The present invention will now be described more fully with reference to the accompanying drawings, in which embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their descriptions will be omitted.

Although the terms first, second, third etc. should not be limited by these terms, these terms are only used to distinguish one element from another element.

The singular forms are intended to include the plural forms as well, unless the context clearly indicates otherwise.

It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

In the drawings, for convenience of description, sizes of elements may be exaggerated or reduced. For example, sizes and thicknesses of elements illustrated in the drawings are arbitrarily indicated for convenience of description and thus are not limited by the present invention.

If an embodiment is differently embodied, a particular process order may be performed differently from an order that will be described. For example, two processes that will be consecutively described may be substantially simultaneously performed or may be performed in an opposite order to an order that will be described.

When layers, areas, elements, etc. are connected to one another, the layers, the areas, the elements, etc. may be directly connected to one another or other layers, areas, elements, etc. may be interposed in the middle of the layers, the areas, and the elements to directly connect the layers, the areas, and the elements.

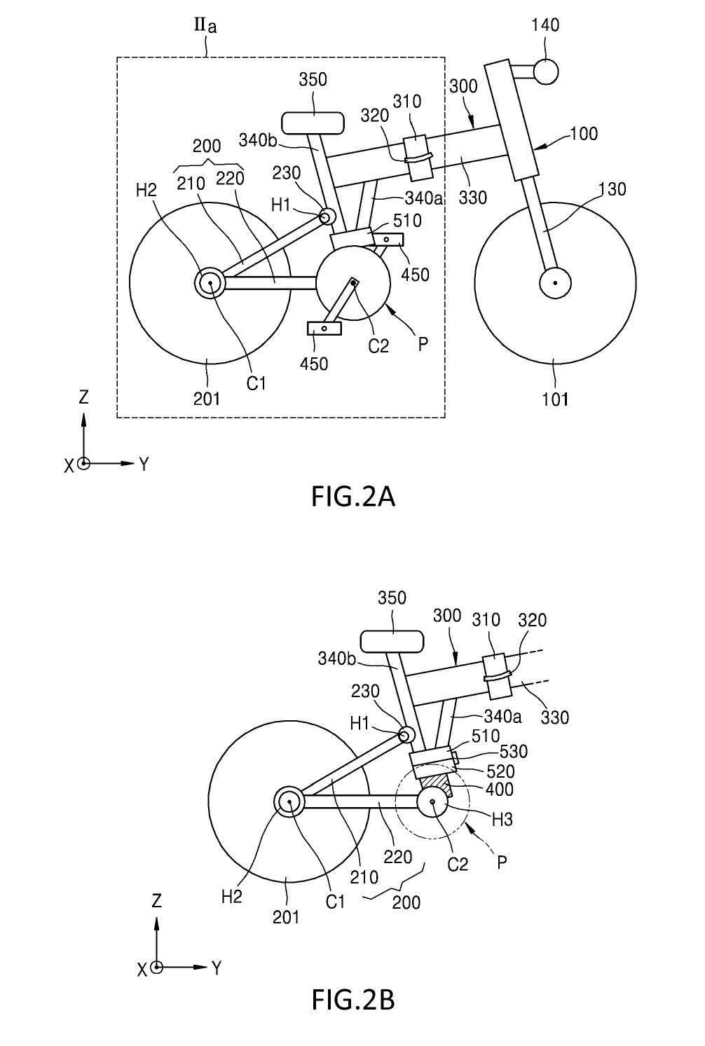

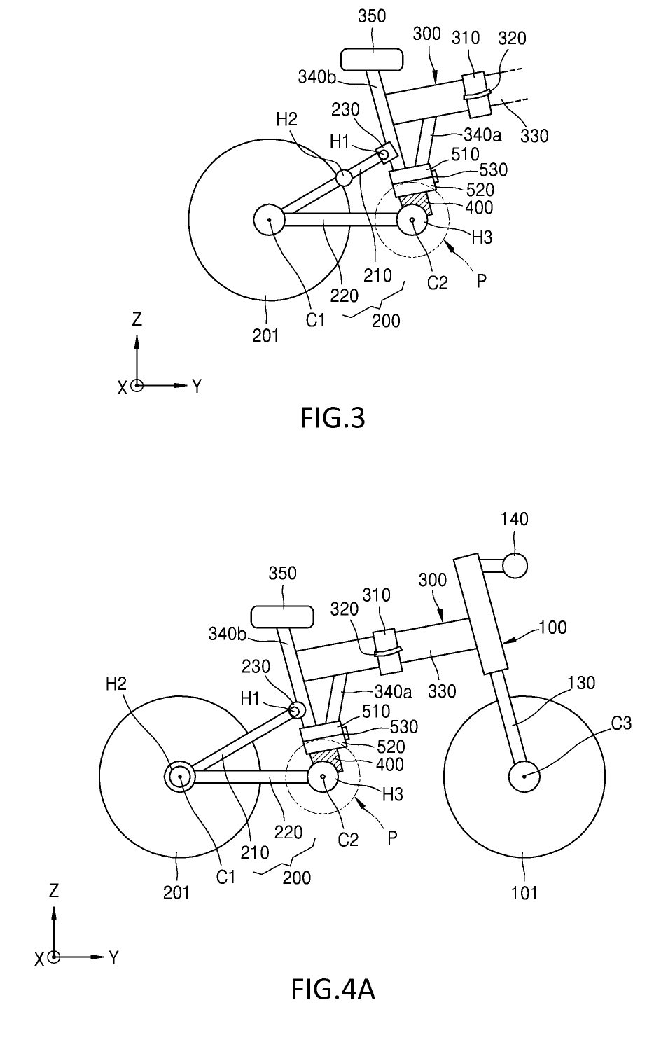

FIG. 2A is a schematic side view of a folding bicycle according to an embodiment. FIG. 2B is a detailed side view of IIa of FIG. 2A. FIG. 3 illustrates a modification of the embodiment of FIG. 2B. For convenience of description, a pedal of FIG. 2A is omitted in FIGS. 2B and 3.

Referring to FIGS. 2A and 2B, the folding bicycle according to the embodiment of the present invention may include a front wheel 101, a rear wheel 201, a saddle 350, a pedal 450, and a frame. The frame may include a front frame 100, a rear frame 200, an upper frame 300, and a pedal frame 400. Although not shown, the pedal 405 and the rear wheel 201 may be connected to each other through a chain, and thus the rear wheel 201 may rotate on a central axis C1 of the rear wheel 201 when the pedal 450 rotates on a pedal axis C2.

The front frame 100 may be connected to the front wheel 101. For example, the front frame 100 is connected to the front wheel 101 through a front assistant frame 130. The rear frame 200 may be connected to the rear wheel 201.

A first hinge unit 230 may be interposed between the rear frame 200 and the upper frame 300. The first hinge unit 230 may be hinge-connected to a first end of the rear frame 200, and thus the rear frame 200 may rotate on the first hinge unit 230. Hereinafter, the hinge connection between the rear frame 200 and the first hinge unit 230 will be referred to as a first hinge connection, and a rotation axis depending on the first hinge connection will be referred to as a first hinge axis H1.

The rear frame 200 may include a first sub-rear frame 210 and a second sub-rear frame 220.

A first end of the first sub-rear frame 210 may be first hinge-connected to the first hinge unit 230, and thus the first sub-rear frame 210 may rotate on the first hinge unit 230. A second end of the first sub-rear frame 210 may be connected to the second sub-rear frame 220.

The first end of the second sub-rear frame 220 may be connected to the first sub-rear frame 210, and a second end of the second sub-rear frame 220 may be connected to a pedal unit P, e.g., to the pedal frame 400. One of the first sub-rear frame 210 and the second sub-rear frame 220 may be connected to the rear wheel 201, and thus the rotation axis C1 of the rear wheel 201 may be formed at one of the first and second sub-rear frames 210 and 220.

The first sub-rear frame 210 and the second sub-rear frame 220 may be hinge-connected to each other. Therefore, if the bicycle is folded, the first and second sub-rear frames 210 and 220 may rotate with regard to each other by a preset angle. For example, when the first sub-rear frame 210 rotates on the first hinge axis H1, the second sub-rear frame 220 may rotate with regard to the first sub-rear frame 210 so as to change an angle between the first and second sub-rear frames 210 and 220. Hereinafter, the hinge connection between the first and second sub-rear frames 210 and 220 will be referred to as a second hinge connection, and a rotation axis depending the second hinge connection will be referred to as a second hinge axis H2.

FIGS. 2A and 2B illustrate the central axis C1 of the rear wheel 201 that is formed to overlap the second hinge axis H2 of the first and second sub-rear frames 210 and 220, but the present invention is not limited thereto. According to another embodiment, as shown in FIG. 3, the central axis C1 of the rear wheel 201 may be formed in a different position from the second hinge axis H2 of the first and second sub-rear frames 210 and 220. In other words, according to an embodiment, as shown in FIG. 3, the second hinge axis H2 may be separated from the central axis C1 of the rear wheel 201 to be positioned in a part of the first sub-rear frame 210. Likewise, a third hinge axis H3 may be selectively positioned to be separated from the pedal axis C2. For example, the third hinge axis H3 may be positioned in a part of the second sub-rear frame 220.

The upper frame 300 is formed to be foldable. The upper frame 300 includes an upper frame folding hinge unit 310 that is folded along a substantially perpendicular direction to a longitudinal direction of the upper frame 300. A rotation of the upper frame folding hinge unit 310 may be controlled by an upper frame fixing key 320.

According to embodiments, if the bicycle is folded, the upper frame fixing key 320 that fixes the upper frame folding hinge unit 310 may be undone, and a side of the upper frame 300 may rotate on the upper frame folding hinge unit 310 toward an other side so as to enable the upper frame 300 to be folded. Thereafter, if the bicycle is used again, the upper frame 300 may rotate on the upper frame folding hinge unit 310 in a reverse direction to be unfolded and fixed by the upper frame fixing key 320.

The upper frame 300 includes a main body 330 that connects the front frame 100 and the rear frame 200 and assistant frame units 340a and 340b that extend under the main body 330 to support a load applied onto the upper frame 300. The assistant frame units 340a and 340b may be formed with the main body 330 as a single body or may be formed separately from the main body 330 to be coupled with the main body 330 through a method such as welding or the like.

The pedal unit P may include the pedal frame 400 and the pedal 450 that is installed at the pedal frame 400.

Referring to FIG. 2B, the pedal frame 400 may be connected to a second end of the rear frame 200. For example, the pedal frame 400 may be hinge-connected to the second end of the second sub-rear frame 200. Hereinafter, the hinge connection between the pedal frame 400 and the second sub-rear frame 220 will be referred to as a third hinge connection, and a rotation axis depending on the third hinge connection will be referred to as a third hinge axis H3. The pedal frame 400 and the second sub-rear frame 220 may rotate with regard to each other on the third hinge axis H3.

A first connection guide 510 may be positioned on a side of the upper frame 300, e.g., under the upper frame 300, and may be connected to the upper frame 300. A second connection guide 520 may be positioned on a side of the pedal frame 400 and connected to the pedal frame 400.

The first and second connection guides 510 and 520 may be controlled by a fixing key to be coupled with or separated from each other. If the bicycle is used, the fixing key 530 may connect the first and second connection guides 510 and 520 to each other. If the bicycle is folded to be unused, the fixing key 530 may separate the first and second connection guides 510 and 520 from each other. According to an unlimited embodiment of the present invention, the fixing key 530 may include a hook, a latch, or the like.

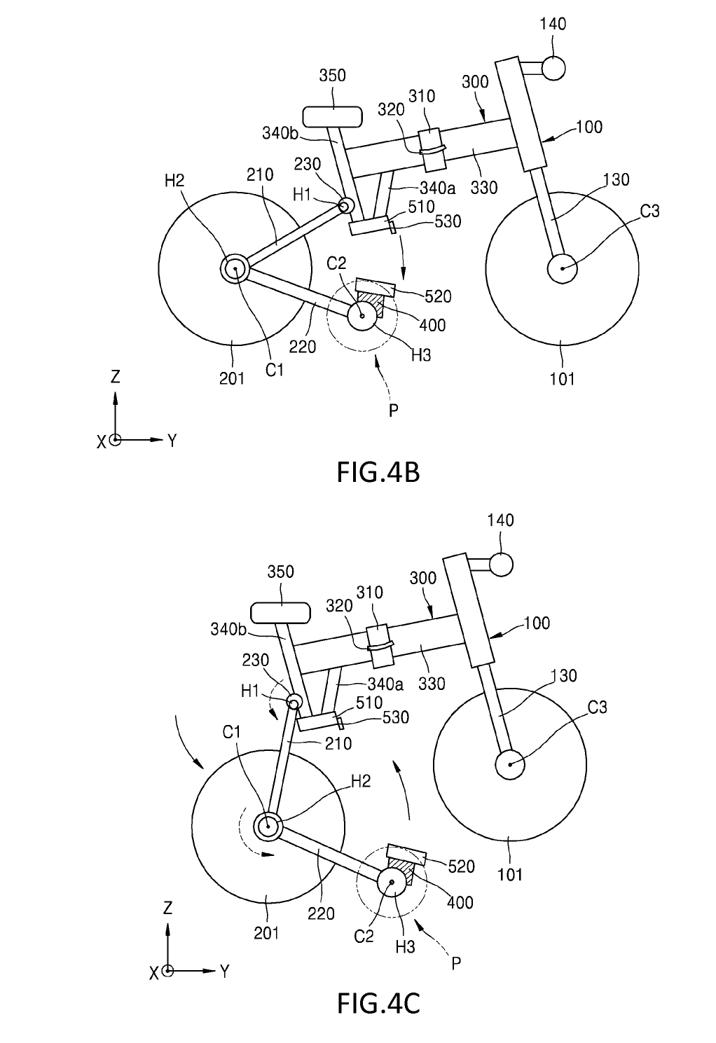

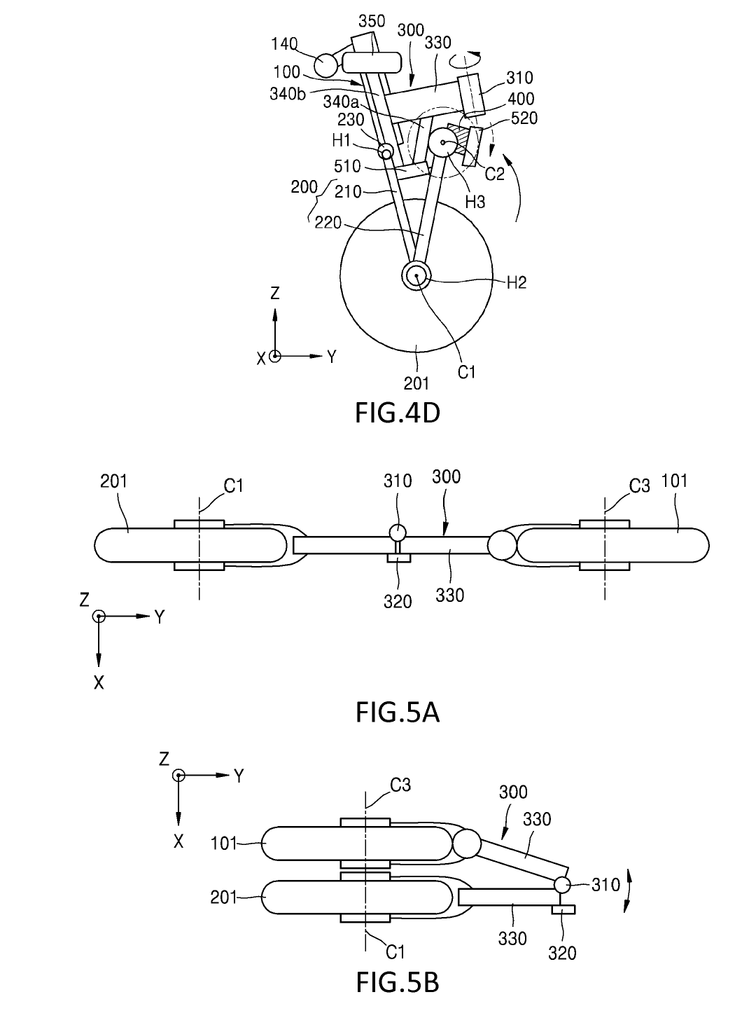

FIGS. 4A through 4D are schematic side views illustrating a process of folding a folding bicycle according to the above-described embodiments. FIG. 5A is an upper side view of FIG. 4A. FIG. 5B is an upper side view of FIG. 4D.

Referring to FIGS. 4A and 4B, if the bicycle is folded to be unused, the first and second connection guides 510 and 520 are separated from each other according to the separation control of the fixing key 530, and thus a motion of the pedal unit P, e.g., the pedal frame 400, becomes free.

Referring to FIGS. 4B and 4C, the rear frame 200 may rotate on the first hinge axis H1 toward the front frame 100 and move under the upper frame 300.

As the first sub-rear frame 210 may rotate with regard to the first hinge unit 230 on the first hinge axis H1, the rear frame 200 may move toward the front frame 100. As the second sub-rear frame 220 may rotate with regard to the first sub-rear frame 210 on the second hinge axis H2, the second sub-rear frame 220 may be adjacent to the assistant frame units 340a and 340b of the upper frame 300.

Referring to FIG. 4D, the pedal frame 400 may rotate on the third hinge axis H3. For example, as shown in FIG. 4D, the pedal frame 400 may rotate on the third hinge axis H3 so as to enable a side of the pedal frame 400, on which the second connection guide 520 is formed, to keep apart from the assistant frame units 340a and 340b.

Referring to FIGS. 4D, 5A, and 5B, the upper frame fixing key 320 provided at the upper frame 300 may be released, and a side of the upper frame 300 may rotate on the upper frame folding hinge unit 310 toward the other side of the upper frame 300 so as to enable the upper frame 300 to be folded. Therefore, the rear frame 200 may be disposed to be substantially parallel with the front frame 100, and the central axis C3 of the front wheel 101 may overlap the central axis C1 of the rear wheel 201.

If the bicycle is used, the folding process described above may be reversely performed to make the bicycle into the state shown in FIGS. 4A and 5A.

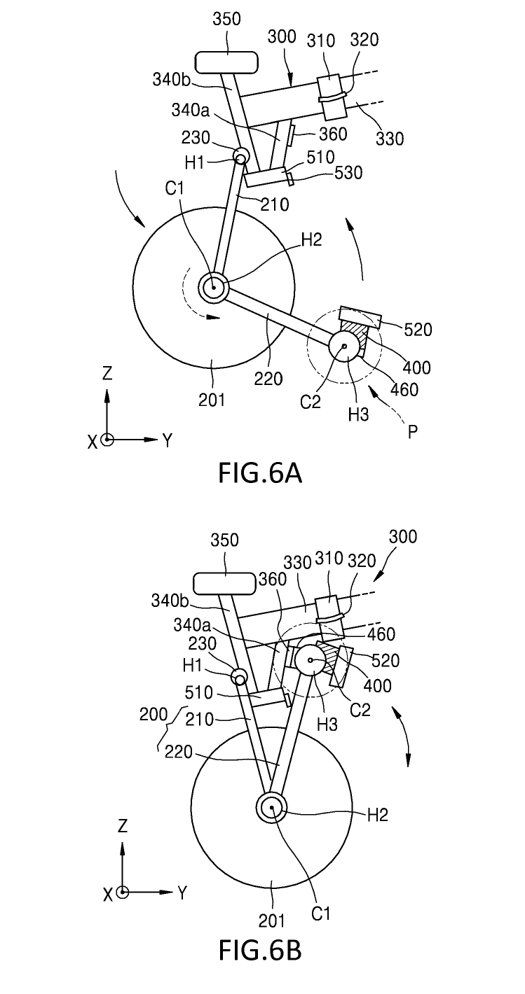

FIGS. 6A and 6B are side views of a part of a folding bicycle according to another embodiment.

Referring to FIGS. 6A and 6B, the folding bicycle according to the present embodiment may further include a fixing member for keeping a folded state of the rear frame 200.

The fixing member may include a first fixing unit 360 formed on a side of the upper frame 300, e.g., at the assistant frame units 340a and 340b, and a second fixing unit 460 formed at the pedal frame 400. The first and second fixing units 360 and 460 may be coupled with each other when the pedal frame 400 is adjacent to the assistant frame units 340a and 340b according to a folding operation of the bicycle described with reference to FIGS. 4A and 4D. In an embodiment, the first and second fixing units 360 and 460 may respectively include magnets to be coupled with each other. In another embodiment, the first and second fixing units 360 and 460 may be coupled with each other through various methods such as a method of using a hook or a latch, etc.

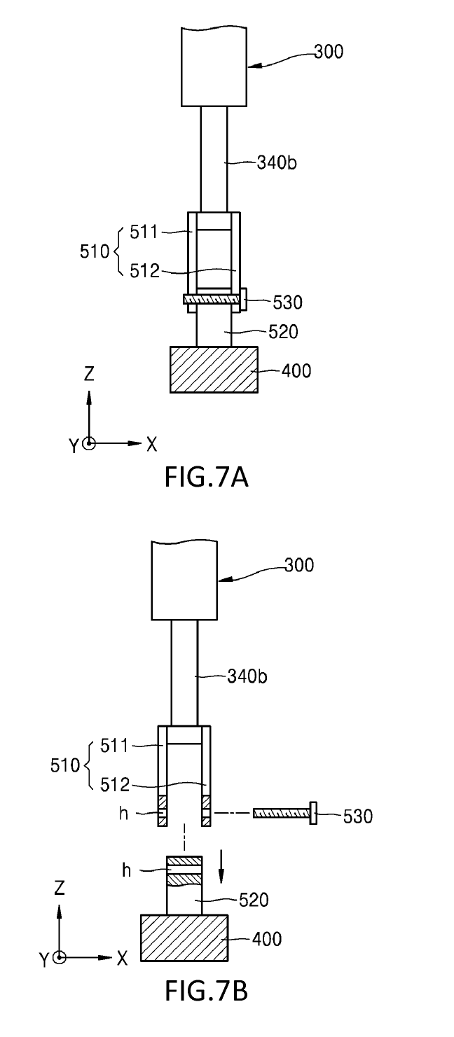

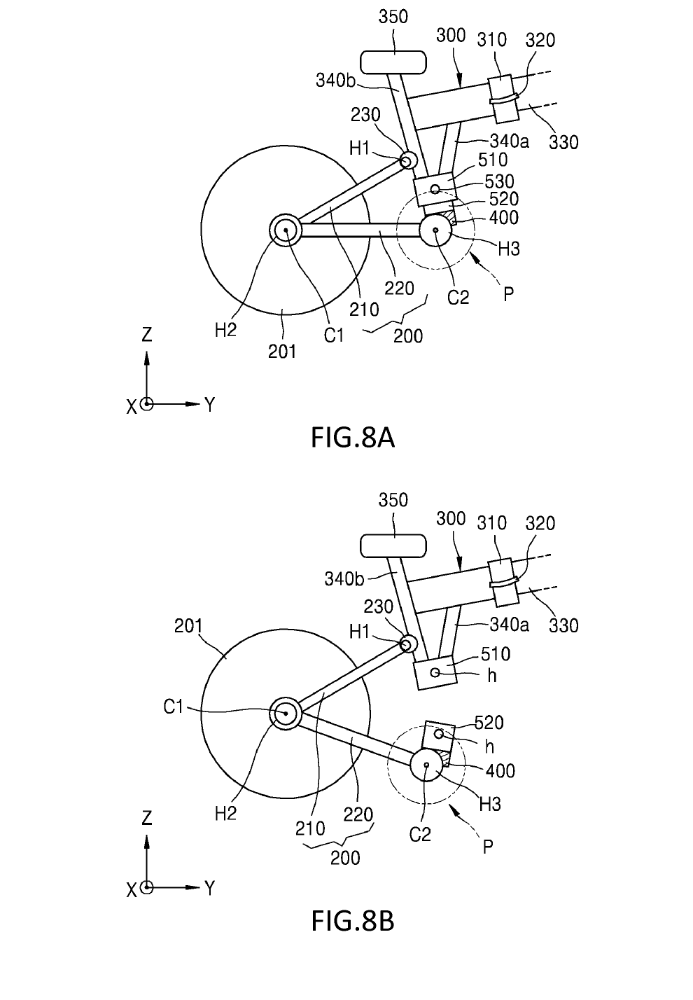

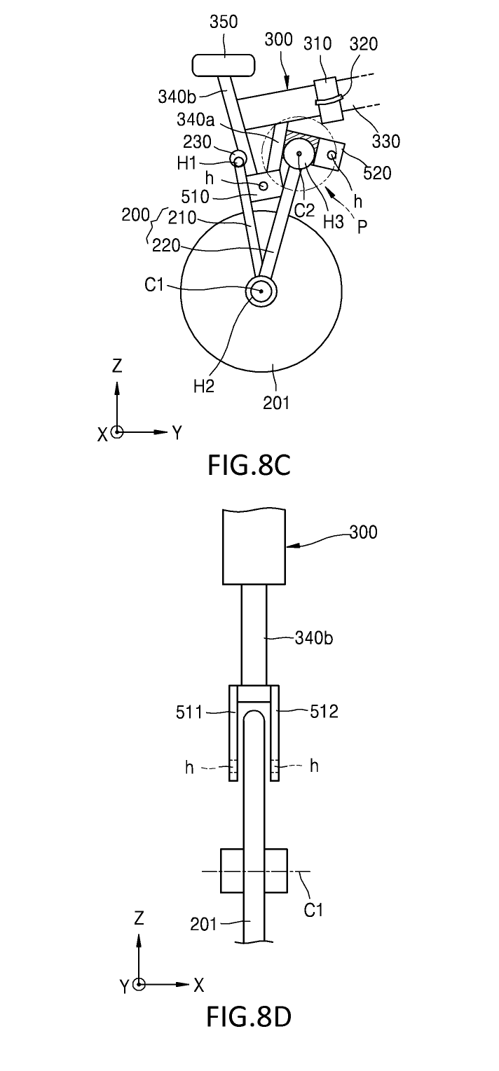

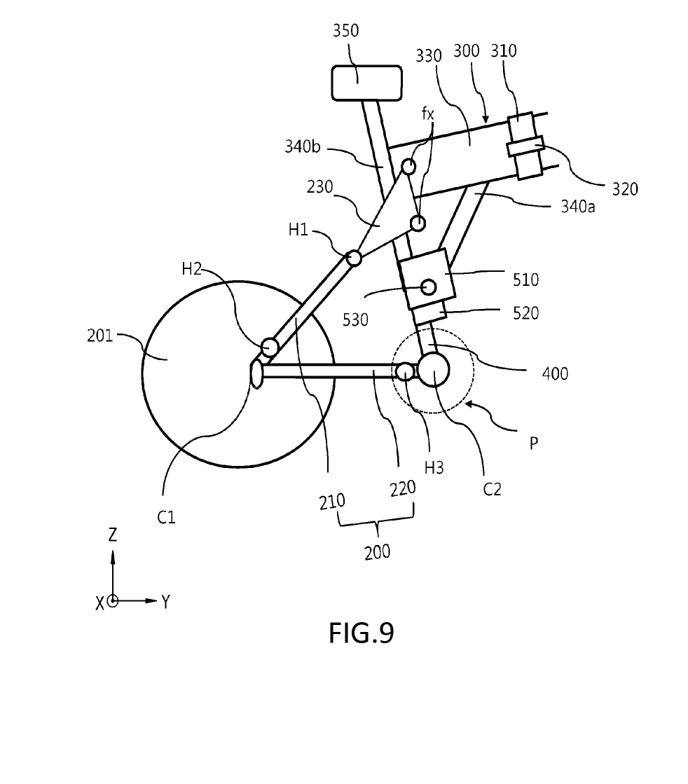

FIGS. 7A and 7B are schematic rear side views of first and second connection guides according to another embodiment. FIGS. 8A through 8C are schematic side views of a part of a folding bicycle including the first and second connection guides of FIGS. 7A and 7B, i.e., illustrate a process of folding the bicycle. FIG. 9D is a schematic rear side view of a first connection guide and a rear wheel of a folding bicycle of FIG. 9C.

Referring to FIGS. 7A and 7B, the first connection guide 510 may be disposed on a side of the upper frame 300, e.g., on a lower side of the upper frame 300, and may be connected to the assistant frame unit 340b of the upper frame 300. A second connection guide 520 may be positioned on a side of the pedal frame 400 and be connected to the pedal frame 400 so as to be coupled with the first connection guide 510.

The first connection guide 510 may include a first guide plate 511 and a second guide plate 512 that are disposed to be parallel with each other. The second connection guide 520 may be inserted between the first and second guide plates 511 and 512. If the fixing key 530 penetrates through holes h of the first and second connection guides 510 and 520 while the second connection guide 520 is disposed between the first and second guide plates 511 and 512, the first and second connection guides 510 and 520 may be coupled with each other.

The first and second guide plates 511 and 512 of the first connection guide 510 may be disposed to keep apart from each other so as to form a space therebetween, and a distance between the first and second guide plates 511 and 512 may be substantially equal to or greater than a width of the rear wheel 201. When folding the bicycle, a part of the rear wheel 201 may be housed in the space formed between the first and second guide plates 511 and 512.

Referring to FIGS. 8A through 8C, if the fixing key 530 is released, the first connection guide 510 and the second connection guide 520 may be separated from each other, and the bicycle may be folded as described with reference to FIGS. 4A through 4D. As the rear frame 200 rotates on the first hinge axis H1, the rear wheel 201 coupled with the rear frame 200 rotates based on the first hinge unit 230 to draw a preset trajectory. The pedal frame 400 may rotate on the third hinge axis H3 so as to be positioned in a direction where the second connection guide 520 keeps apart from the assistant frame unit 340a.

Referring to FIG. 8D, a part of the rear wheel 201 may be housed in the space between the first and second guide plates 511 and 512.

FIG. 9 is a detailed side view of a part of a folding bicycle including the first and second connection guides described with reference to FIGS. 7A and 7B.

Referring to FIG. 9, the first hinge unit 230 is interposed between the rear frame 200 and the upper frame 300 to connect the rear frame 200 and the upper frame 300. The first hinge unit 230 may be formed in a triangular shape but is not limited thereto. The first hinge axis H1 is formed on a side of the first hinge unit 230, e.g., in a connection position to the first sub-rear frame 210, and an other side of the first hinge unit 230, e.g., a connection position to the upper frame 300, is a fixing unit fx. The other side of the first hinge unit 230 may be fixed respectively to the main body 330 and the assistant frame unit 340b. According to the embodiment shown in FIG. 9, the second hinge axis H2 may be positioned in a part of the first sub-rear frame 210 separated from the central axis C1 of the rear wheel 201, and the third hinge axis H3 may be positioned or fixed fx in a part of the second sub-rear frame 220 or the pedal frame 400 separated from the pedal axis C2.

If the bicycle is folded to be unused, the fixing key 530 is undone to separate the first and second connection guides 510 and 520. As the second connection guide 520 is separated from the first connection guide 510, the first sub-rear frame 210 of the rear frame 200 may rotate on the first hinge axis H1 formed at the first unit 230, the second sub-rear frame 200 may rotate on the third hinge axis H3, and the pedal frame 400 may rotate on the third hinge axis H3.

According to the present embodiment, a preset space is formed between the first and second guide plates 511 and 512 of the first connection guide 510. Therefore, when the rear frame 200 rotates toward the front frame 300 by rotations of the first and second sub-rear frames 210 and 220, a part of the rear wheel 201 connected to the rear frame 200 may be housed in the space between the first and second guide plates 511 and 512.

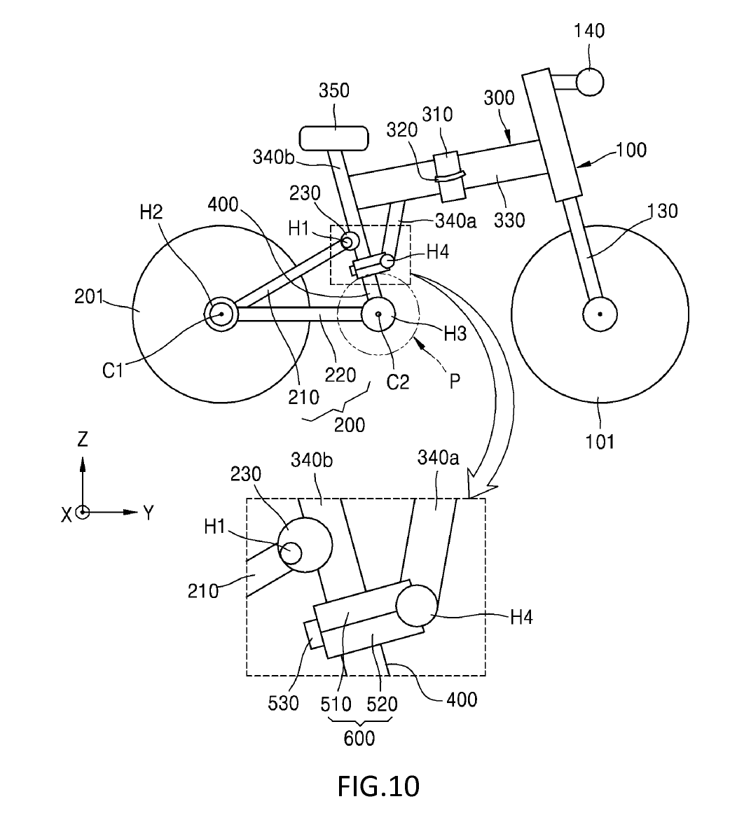

FIG. 10 is a schematic side view of a folding bicycle according to another embodiment.

Referring to FIG. 10, like the bicycle described with reference to FIGS. 2A and 2B, the folding bicycle according to the present embodiment may include the front frame 100, the rear frame 200 having the first and second sub-rear frames 210 and 220, the upper frame 300, and the pedal frame 400. The first sub-rear frame 210, the second sub-rear frame 220, and the pedal frame 400 may respectively rotate on the first, second, and third hinge axes H1, H2, and H3.

In the folding bicycle described with reference to FIGS. 2A through 9, the first and second connection guides 510 and 520 are separated from each other. However, in the folding bicycle according to the present embodiment, a pedal unit P moves through a pedal frame hinge unit 600.

In the present embodiment, the same members as those of the folding bicycle described with reference to FIGS. 2A through 9 are denoted by the same reference numerals, their repeated descriptions are omitted, and their differences will be mainly described.

Referring to FIG. 10, the pedal frame hinge unit 600 may include the first connection guide 510 and the second connection guide 520 that are hinge-connected to each other. Ends of the first and second connection guides 510 and 520 may be separated from each other, and other ends of the first and second connection guides 510 and 520 may be hinge-connected to each other to rotate with regard to each other. Hereinafter, the hinge connection between the first and second connection guides 510 and 520 will be referred to as a fourth hinge connection, and a rotation axis depending on the fourth hinge connection will be referred to as a fourth hinge axis H4.

The first connection guide 510 may be positioned on a side of the upper frame 300, e.g., a lower side, and may be connected to the upper frame 300. In more detail, the first connection guide 510 may be connected to an assistant frame unit 340b. The second connection guide 520 may be positioned on a side of the pedal frame 400, e.g., an upper side, and may be connected to the pedal frame 400.

Locking and unlocking of the first and second connection guides 510 and 520 may be controlled by the fixing key 530. If the bicycle is used, the fixing key 530 is in a locking state, and thus the first and second connection guides 510 and 520 are position-fixed with regard to each other so as to enable the pedal frame 400 to be fixed to the upper frame 300. If the bicycle is folded to be unused, the fixing key 530 is in a unlocking state, and thus the second connection guide 520 may rotate on the fourth hinge axis H4 with regard to the first connection guide 510 by a preset angle, and the pedal frame 400 may rotate along with the rotation of the first connection guide 510.

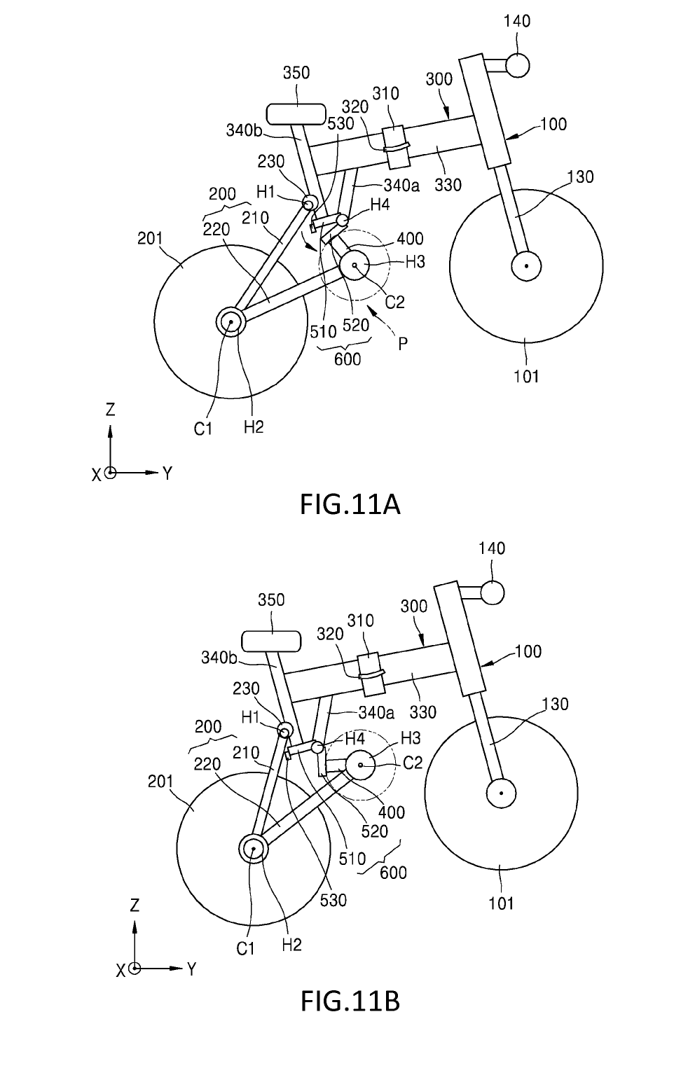

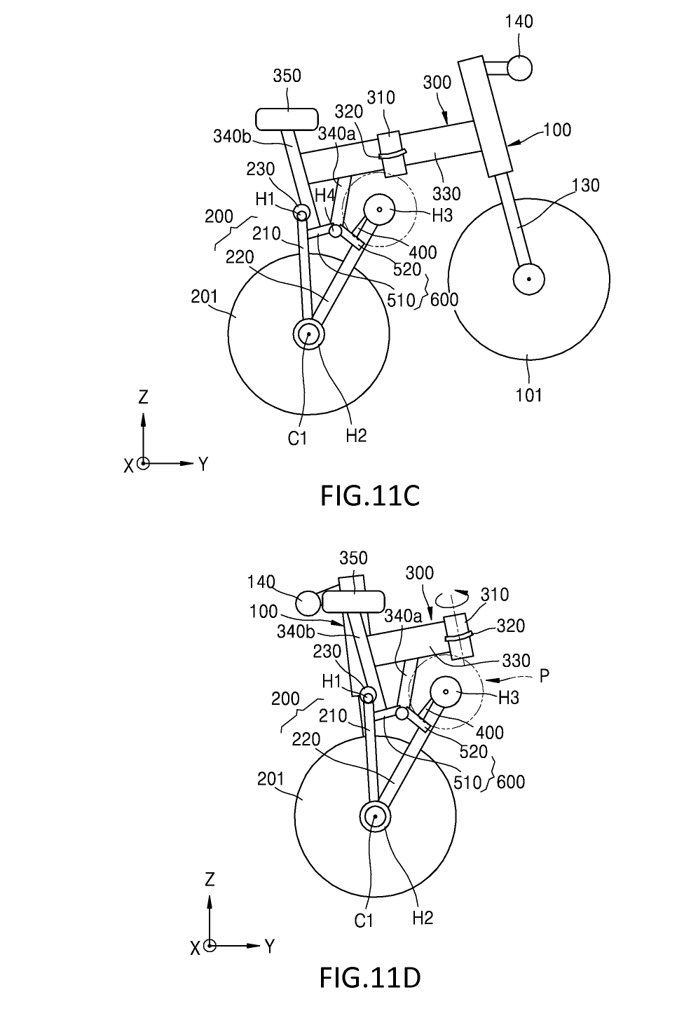

FIGS. 11A through 11D are schematic side views of a process of folding the folding bicycle of FIG. 10.

Referring to FIGS. 11A and 11B, the second connection guide 520 of the pedal frame hinge unit 600 rotates with regard to the first connection guide 510 on the fourth hinge axis H4 by a preset angle according to unlocking control of the fixing key 530. The pedal frame 400 connected to the second connection guide 520 may rotate according to the rotation of the second connection guide 520.

Referring to FIG. 11C, the rear frame 200 may rotate on the first hinge axis H1 toward the front frame 100 to move down the upper frame 300.

The first sub-rear frame 210 rotates with regard to the first hinge unit 230 on the first hinge axis H1 to move toward the front frame 100. The second sub-rear frame 220 may rotate with regard to the first sub-rear frame 210 on the second hinge axis H2, and the pedal frame 400 may rotate on the fourth hinge axis H4 to be disposed adjacent to the upper frame 300, e.g., the assistant frame unit 340a of the upper frame 300. The second sub-rear frame 220 relatively rotates with regard to the pedal frame 400 on the third hinge axis H3.

Thereafter, as shown in FIG. 11D, an upper frame fixing key 320 provided at the upper frame 300 may be released, and a side of the upper frame 300 may rotate toward the other side of the upper frame 300 on an upper frame folding hinge unit 310 so as to enable the upper frame 300 to be folded.

If the bicycle is used, the above-described process may be reversely performed so as to enable the bicycle to be in a state shown in FIG. 11A.

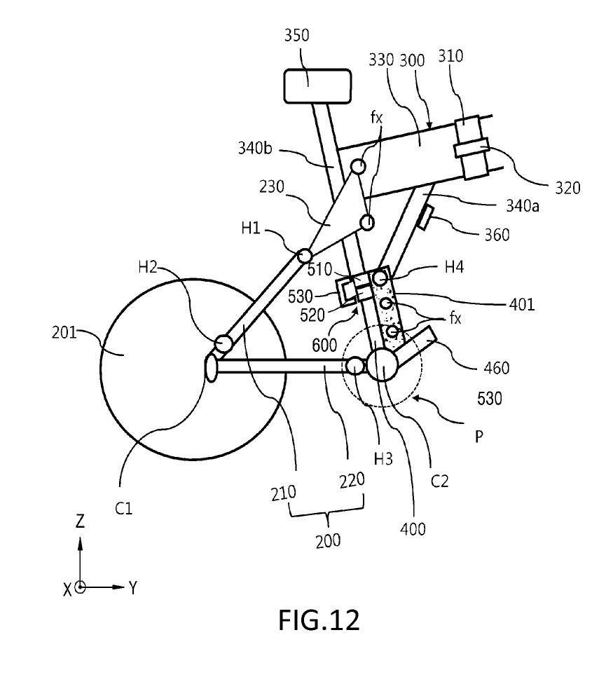

FIG. 10 and FIGS. 11A through 11D illustrate the central axis C1 of the rear wheel 201 that overlaps the second hinge axis H2 of the first and second sub-rear frames 210 and 220, but the present invention is not limited thereto. According to another embodiment, as shown in FIG. 12, the central axis C1 of the rear wheel 201 may be formed in a different position from the second hinge axis H2 of the first and second sub-rear frames 210 and 220.

FIG. 12 is a detailed side view of a folding bicycle according to another embodiment of the present invention.

Referring to FIG. 12, the first hinge unit 230 may be interposed between the rear frame 200 and the upper frame 300 to connect the rear frame 200 and the upper frame 300, the first hinge axis H1 may be formed on a side of the first hinge unit 230, e.g., in a connection position to the first sub-rear frame 210, and an other side of the first hinge unit 230, e.g., a connection position to the upper frame 300, is a fixing unit fx. The fixing unit fx may be positioned at a connection part of the first hinge unit 230 and the main body 330, and a connection part of the first hinge unit 230 and the assistant frame unit 340b.

The central axis C1 of the rear wheel 201 may be formed in a different position from the second hinge axis H2 of the first and second sub-rear frames 210 and 220. For example, the second hinge axis H2 may be positioned in a part of the first sub-rear frame 210 spaced apart from the central axis C1 of the rear wheel 201. The pedal axis C2 is formed in a different position from the third hinge axis H3. For example, the third hinge axis H3 may be positioned in a part of the second sub-rear frame 220 or the pedal frame 400 spaced apart from the pedal axis C2.

A connection plate 401 is coupled with the first connection guide 510, the second connection guide 520, and the pedal frame 400. The connection plate 401 and the first connection guide 510 are coupled to rotate on the fourth hinge axis H4. The connection plate 401, the second connection guide 520, and the pedal frame 400 are fixedly coupled (fx).

If the bicycle is folded, the fixing key 530 is undone to keep the second connection guide 520 in a state where the second connection guide 520 may rotate with regard to the first connection guide 510 on the fourth hinge axis H4. Since the second connection guide 520 is in a state where the second connection guide 520 is rotatable with regard to the first connection guide 510, a movement of the pedal frame 400 coupled with the second connection guide 520 relatively becomes free.

The first sub-rear frame 210 of the rear frame 200 may rotate on the first hinge axis H1 formed at the first hinge unit 230, the second sub-rear frame 220 may rotate on the second hinge axis H2, the pedal frame 400 may rotate on the fourth hinge axis H4, and the second sub-rear frame 220 may rotate relatively with regard to the pedal frame 400 on the third hinge axis H3. According to this rotation operation, the rear frame 200 may rotate toward the front frame 300. The upper frame 300 may release the upper frame fixing key 320 to be folded based on the upper frame folding hinge unit 310.

The folding bicycle according to the present embodiment may include first and second fixing units 360 and 460 as fixing members for keeping a folded state of the rear frame 200. When the pedal frame 400 rotates on the forth hinge axis H4, the second fixing unit 460 formed at the pedal frame 400 may be coupled with the first fixing unit 360, and thus a folded state of the bicycle may be kept.

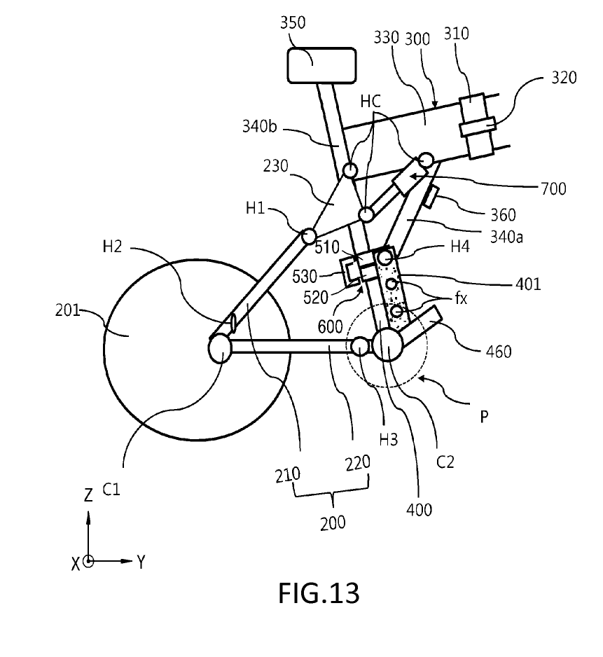

FIG. 13 illustrates a modification of the folding bicycle of FIG. 12.

Referring to FIG. 13, a shock absorber 700 may be further included between the first hinge unit 230 and the upper frame 300 of the folding bicycle. The first hinge axis H1 may be formed on a side of the hinge unit 230, e.g., in a connection position to the first sub-rear frame 210, a hinge axis HC may be formed on an other side of the first hinge unit 230, e.g., in a connection position to the upper frame 300 and a connection position to the shock absorber 700, and the hinge axis HC may be formed between an other end of the shock absorber 700 and the upper frame 300 so as to absorb shocks applied when the bicycle runs. According to an unlimited embodiment of the present invention, the shock absorber 700 may be an elastic spring-type. However, the present invention is not limited thereto, and thus various types of shock absorbers, such as a hydraulic type, a gas compressive type, etc., may be used.

In the present embodiment, the shock absorber 700 is installed at the folding bicycle including the pedal frame hinge unit 600 and the fixing key 530, but the present invention is not limited thereto. In other embodiments, the shock absorber 700 may be installed at the folding bicycle according to the embodiments described above with reference to FIGS. 2A through 9.

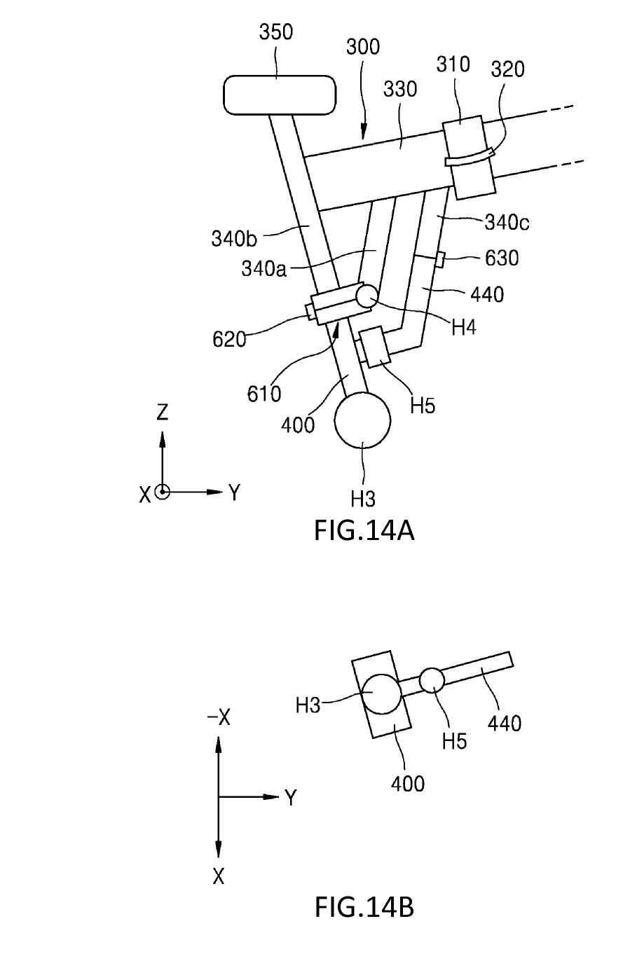

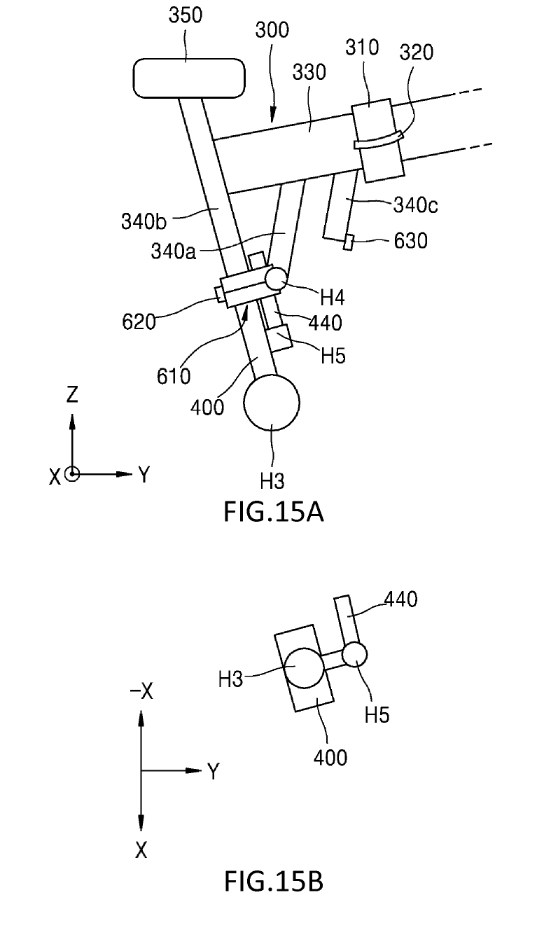

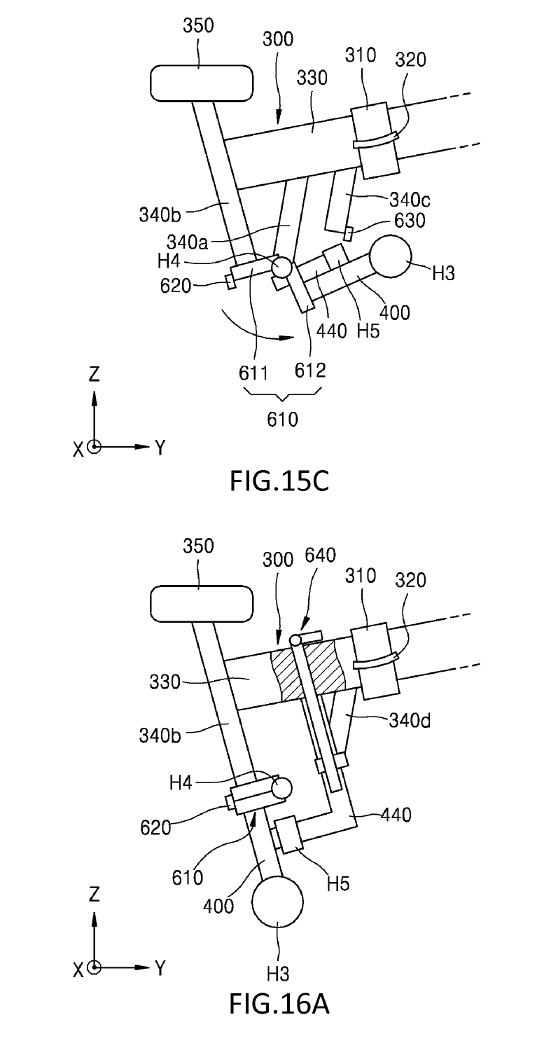

FIG. 14A is a side view of an upper frame and a pedal frame of a folding bicycle according to an embodiment. FIG. 14B is a lower side view of a pedal frame and a pedal assistant frame unit of FIG. 14A. FIG. 15A is a side view of a rotation of the pedal assistant frame unit of FIG. 14A. FIG. 15B is a lower side view of a rotation of the pedal assistant frame unit of FIG. 15A. FIG. 15C is a side view of rotation of a pedal frame in a state of FIG. 15B.

Referring to FIGS. 14A and 14B, the upper frame 300 may further include an upper assistant frame unit 340c, and the pedal frame 400 may further include a pedal assistant frame unit 440. The upper assistant frame unit 340c and the pedal assistant frame unit 440 may extend toward each other and may be coupled with or separated from each other by an assistant fixing key 630. The assistant fixing key 630 may couple or separate the upper assistant frame unit 340c and the pedal assistant frame unit 440 through various types of structures such as a hook, a rack, etc.

If the bicycle is used, the upper assistant frame unit 340c and the pedal assistant frame unit 440 that are coupled with each other by the assistant fixing key 630 may perform a function of diffusing a load applied to a frame.

An end of the pedal assistant frame unit 440 may be hinge-connected to the pedal frame 400. Hereinafter, the hinge connection between the pedal frame 400 and the pedal assistant frame unit 440 will be referred to as a fifth hinge connection, a rotation axis depending on the fifth hinge connection will be referred to as a fifth hinge axis H5.

Referring to FIGS. 15A and 15B, if the bicycle is folded, the upper assistant frame unit 340c and the pedal assistant frame unit 440 may be separated from each other by an undoing operation of the assistant fixing key 630, and the pedal assistant frame unit 440 may rotate on the fifth hinge axis H5. For example, the pedal assistant frame unit 440 that are placed in a direction y of FIGS. 15A and 15B may rotate on the fifth hinge axis H5 to be placed in a direction −x.

Referring to FIG. 15C, the second connection guide 520 of the pedal frame hinge unit 600 may rotate so as to enable the pedal assistant frame unit 440 to rotate with the pedal frame 400 by a preset angle.

The embodiment of the pedal assistant frame unit 440, an upper assistant frame unit 340d, and the assistant fixing key 630 may be applied to the folding bicycle according to the embodiments described with reference to FIGS. 2A through 9.

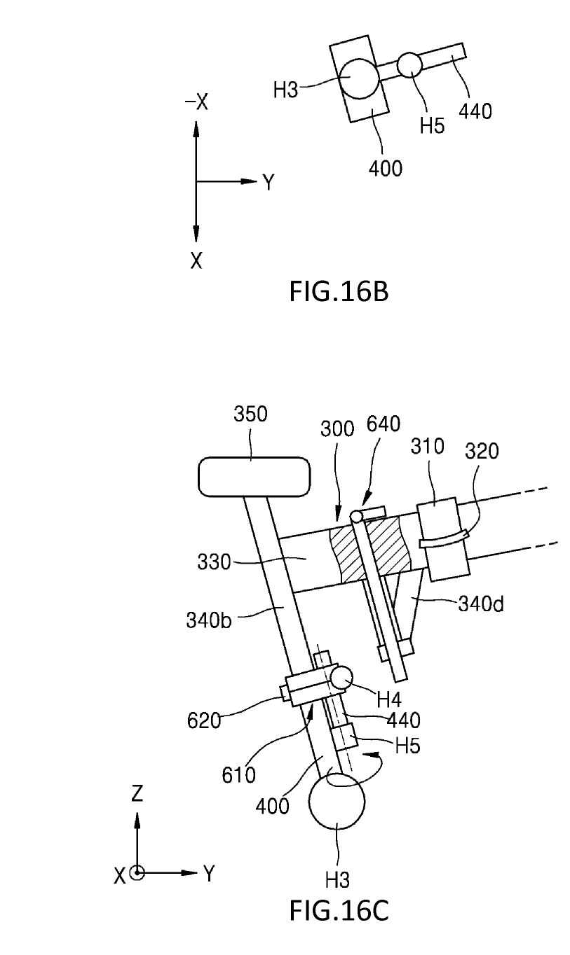

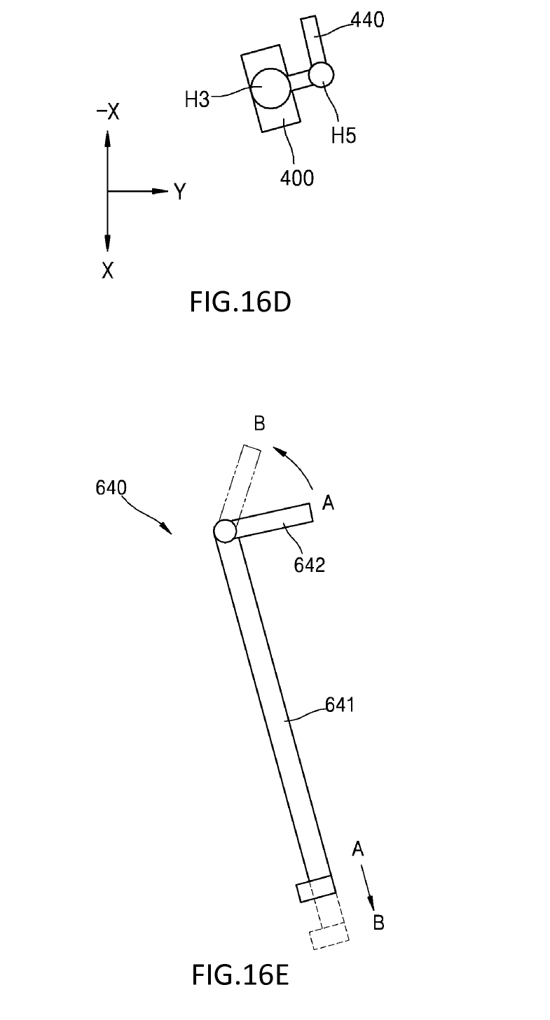

FIG. 16A is a side view of an upper frame and a pedal frame of a folding bicycle according to another embodiment. FIG. 16B is a lower side view of the pedal frame and a pedal assistant frame unit of FIG. 16A. FIG. 16C is a side view illustrating a rotation of the pedal assistant frame unit of FIG. 16A. FIG. 16D is a lower side view illustrating a rotation of the pedal assistant frame unit of FIG. 16C. FIG. 16E is a detailed side view of an assistant fixing key of FIG. 16A.

Referring to FIG. 16A, the upper frame 300 may further include the upper assistant frame unit 340d, and the pedal frame 400 may further include the pedal assistant frame unit 440. An end of the pedal assistant frame unit 440 may be connected to the pedal frame 400 through a fifth hinge. The upper assistant frame unit 340d and the pedal frame unit 440 may extend toward each other and may be coupled with or separated from each other by an assistant fixing key 640.

Referring to FIGS. 16A and 16E, the assistant fixing key 640 may include a fixing shaft 641, a fixing lever 642, and a fixing key 643 that penetrate through the pedal assistant frame unit 440, the upper assistant frame unit 340d, and the main body 330 of the upper frame 300.

Referring to FIGS. 16A through 16E, if the fixing lever 642 is moved from a fixing position A to an undoing position B, the fixing key 643 provided at an end of the fixing shaft 641 may move and thus the pedal assistant frame unit 440 may separate from the upper assistant frame unit 340d. The upper assistant frame unit 340d and the pedal assistant frame unit 440 may be separated from each other by releasing operation of the assistant fixing key 640, and the pedal assistant frame unit 440 may rotate on the fifth hinge axis H5. For example, referring to FIGS. 16C and 16D, the pedal assistant frame unit 440 placed in the direction y may rotate on the fifth hinge axis H5 placed in the direction −x.

Thereafter, as the second connection guide 520 of the pedal frame hinge unit 600 may rotate on the fifth hinge axis H4, the pedal assistant frame unit 440 and the pedal frame 400 may rotate by a preset angle.

If a structure of the fixing key 643 is not limited to the structure of FIG. 16E and is a structure capable of releasing a coupling between the pedal assistant frame unit 440 and the upper assistant frame unit 340d through a movement of the fixing shaft 641, the fixing key 643 may rotate through the movement of the fixing shaft 641, etc., and a structure of the fixing key 643 may not be limited.

The embodiment of the pedal assistant frame unit 440, the upper assistant frame unit 340d, and the assistant fixing key 640 may be applied to the folding bicycle according to the embodiments described with reference to FIGS. 2A through 9.

In the folding bicycle according to the embodiments described above, when the pedal unit P is separated from the upper frame 300 to be easily moved or is relatively easily moved by using a hinge, the rear frame 200 may rotate on a hinge axis. In other words, the rear frame 200 may rotate toward the front frame 100 to be placed under the upper frame 300. Therefore, in comparison to a folding bicycle where only the upper frame 300 is folded, a space occupied by the bicycle that is in a folded state may be reduced, and thus keeping, transporting, and carrying may be improved.

While one or more embodiments have been described with reference to the figures, it will be understood by those of ordinary skill in the art that various changes in form and details may be made therein without departing from the spirit and scope as defined by the following claims.

What is claimed is:

1. A folding bicycle comprising:
a front frame connected to a front wheel;
a rear frame connected to a rear wheel;
an upper frame connected to a first end of the rear frame and which is foldable;
a pedal frame connected to a second end of the rear frame;
a first hinge unit interposed between the first end of the rear frame and the upper frame and hinge-connectable to the first end of the rear frame;
a first connection guide configured to be positioned on a side of the upper frame; and
a second connection guide configured to be positioned on a side of the pedal frame opposite to the first connection guide.

2. The folding bicycle of claim 1, wherein the second connection guide is coupled with the first connection guide so as to be separated from the first connection guide,
wherein when the second connection guide is separated from the first connection guide, the rear frame rotates with respect to the first hinge unit toward the front frame.

3. The folding bicycle of claim 1, wherein the first connection guide and the second connection guide are connected to each other by a hinge axis to form a pedal frame hinge unit,
wherein when the pedal frame rotates on the hinge axis, the first end of the rear frame rotates with regard to the first hinge unit toward the front frame.

4. The folding bicycle of any one of claims 1 through 3, wherein the rear frame comprises:
a first sub-rear frame, wherein an end of the first sub-rear frame is hinge-connected to the first hinge unit; and
a second sub-rear frame, wherein an end of the second sub-rear frame coupled with another end of the first sub-rear frame, and another end of the second sub-rear frame connected to the pedal frame,
wherein a rotation axis of the rear wheel is formed in at least one selected from the first and second sub-rear frames.

5. The folding bicycle of claim 4, wherein the second sub-rear frame is hinge-connected to the another end of the first sub-rear frame,
wherein a hinge axis, which is formed by a hinge-connection between the first sub-rear frame and the second sub-rear frame, is located in a position different from a position of a rotation axis of the rear wheel.

6. The folding bicycle of any one of claims 1 through 3, wherein the pedal frame is hinge-connected to the second end of the rear frame,
wherein a hinge axis, which is formed by a hinge-connection between the pedal frame and the second end of the rear frame, is located in a position different from a position of a pedal axis.

7. The folding bicycle of any one of claims 1 through 3, further comprising:
a first fixing unit formed at the upper frame; and
a second fixing unit formed at the rear frame or the pedal frame, and coupled with the first fixing unit when the rear frame rotates.

8. The folding bicycle of any one of claims 1 through 3, further comprising:
a shock absorber comprising an end connected to the first hinge unit and another end connected to the upper frame.

9. The folding bicycle of any one of claims 1 through 3, wherein the pedal frame further comprises a pedal assistant frame, wherein an end of pedal assistant frame is hinge-connected to the pedal frame and configured to extend in one direction, and the upper frame further comprises an upper assistant frame configured to extend toward the pedal assistant frame,
wherein an assistant fixing key is further comprised to couple or separate the pedal assistant frame and the upper assistant frame.

10. The folding bicycle of any one of claims 1 through 3, further comprising:
a fixing key configured to control coupling or separating the first connection guide and the second connection guide.
